(19) United States
(12) Patent Application Publication
(10) Pub. No.: US 2012/0145010 A1
(43) Pub. Date: Jun. 14, 2012

(54) AIR CLEANER

(76) Inventor: Yoshiro Yamamoto, Osaka-shi (JP)

(21) Appl. No.: 13/392,374

(22) PCT Filed: Aug. 18, 2010
(86) PCT No.: PCT/JP2010/063912

§ 371 Date: Feb. 24, 2012

(30) Foreign Application Priority Data
Aug. 27, 2009 (JP) 2009-196935
Aug. 27, 2009 (JP) 2009-196937

(51) Int. Cl. B01D 46/42

(52) U.S. Cl. 96/397

(57) ABSTRACT

A case of an air cleaner includes an inlet, through which the outside air is taken in by rotation of an internal fan. The outside air taken in passes through a filter from the inlet in a first flow path. A sensor unit is arranged outside of the first flow path, and the outside air taken in passes through the sensor unit from the inlet by a flow path pipe forming a second flow path different from the first flow path. As a result, the outside air taken in through the flow path different from the flow path toward the filter is sensed by the sensor unit.

### TECHNICAL FIELD

The present invention relates to air cleaners, and more particularly to an air cleaner including a sensor.

### BACKGROUND ART

As a conventional air cleaner, Japanese Patent Laying-Open No. 63-229117 (PTL 1) discloses an air cleaner which detects a degree of air pollution by an internal gas sensor, and whose operation is controlled based on a result of the detection. An air cleaner including a gas sensor, however, may not always accurately detect a degree of pollution as temperature variations occur during switching of an air-blowing amount and the like. To address this problem, Japanese Patent Laying-Open No. 2000-186848 (PTL 2) discloses an air conditioner capable of detecting a degree of pollution while minimizing temperature variations in a sensor unit by installing a gas sensor, which is housed in a casing sealed except for a vent, in a flow path within the conditioner.

### CITATION LIST

### Patent Literature

PTL 1: Japanese Patent Laying-Open No. 63-229117
PTL 2: Japanese Patent Laying-Open No. 2000-186848

### SUMMARY OF INVENTION

### Technical Problem

In PTL 2, however, since the vent is only provided in one surface of the casing, the air to be sensed is nearly unchanged within the casing, which may result in failure to accurately sense the outside air.

In addition, installing the gas sensor directly in the flow path within the conditioner causes reduction in sensing accuracy when a flow rate or a flow volume is too high for sensing by the sensor. If the flow volume or the flow rate in the conditioner is rendered suitable for the sensing by the sensor, however, performance of an air cleaning mechanism may be lowered.

Furthermore, if the gas sensor is installed downstream of the air cleaning mechanism in the flow path within the conditioner, the gas sensor will sense the air that has been cleaned, and cannot accurately sense the outside air.

The present invention was made in view of these problems, and one object of the present invention is to provide an air cleaner including a sensor, with improved sensing accuracy of the internal sensor. Another object is to provide an air cleaner capable of accurately sensing the air outside of the cleaner by the internal sensor while performance of an air cleaning mechanism is ensured.

### Solution to Problem

In order to achieve the above objects, according to an aspect of the present invention, an air cleaner includes a case including an inlet and an outlet, an air cleaning mechanism in the case for cleaning air taken in through the inlet, a sensor mechanism in the case for sensing the air taken in through the inlet, and a flow volume control mechanism for controlling the air taken in through the inlet such that a flow rate of the air passing through the sensor mechanism is lower than a flow rate of the air passing through the air cleaning mechanism.

Preferably, the flow volume control mechanism is a flow path wall for separating an airflow from the inlet to the sensor mechanism, from an airflow from the inlet to the air cleaning mechanism.

Preferably, the flow volume control mechanism includes at least one of a member provided upstream of the sensor mechanism for interfering with an inflow of air into the sensor mechanism, and a member provided downstream of the sensor mechanism for interfering with discharge of air from the sensor mechanism.

According to another aspect of the present invention, an air cleaner includes a case including an inlet for taking in outside air from outside, and an outlet for discharging the air therein to outside, and an air cleaning mechanism, a sensor mechanism, and an airflow generation device housed in the case, in which the air cleaning mechanism cleans the air taken into the case through the inlet and passing through the air cleaning mechanism by driving of the airflow generation device, the sensor mechanism senses the air taken into the case through the inlet and passing through the sensor mechanism by driving of the airflow generation device, to detect a substance to be sensed contained in the air, and the sensor mechanism is arranged in the case, upstream of the air cleaning mechanism in a flow path where the air taken into the case through the inlet by driving of the airflow generation device passes through the air cleaning mechanism from the inlet.

Preferably, the air cleaner further includes a flow volume control mechanism for making a flow rate of the air passing through at least the sensor mechanism lower than a flow rate of the air reaching the sensor mechanism from the inlet by driving of the airflow generation device.

More preferably, the sensor mechanism includes an inlet and an outlet upstream and downstream thereof, respectively, and the flow volume control mechanism includes a member in contact with the at least one of a surface having the inlet of the sensor mechanism and a surface having the outlet of the sensor mechanism, for changing an opening area of the inlet or the outlet.

More preferably, the member for changing an opening area is joined such that an angle formed with the at least one of the surface having the inlet of the sensor mechanism and the surface having the outlet of the sensor mechanism is variable, and changes the opening area of the inlet or the outlet by control of the angle.

More preferably, the member for changing an opening area is joined in a manner slidable parallel or substantially parallel to the at least one of the surface having the inlet of the sensor mechanism and the surface having the outlet of the sensor mechanism, and changes the opening area of the inlet or the outlet by control of an amount of sliding.

### Advantageous Effects of Invention

According to the present invention, the sensing accuracy of the internal sensor can be improved. Further, according to the present invention, the sensor included in the air cleaner can accurately sense the air outside of the cleaner while the performance of the cleaning mechanism in the air cleaner is ensured.

### BRIEF DESCRIPTION OF DRAWINGS

FIG. 1 shows a specific example of appearance of an air cleaner according to an embodiment.

FIG. 2 shows a schematic cross section as another specific example of the air cleaner according to the embodiment.

FIG. 3A shows a first example of the schematic cross section of the air cleaner according to a first embodiment.

FIG. 3B shows a second example of the schematic cross section of the air cleaner according to the first embodiment.

FIG. 4 shows a third example of the schematic cross section of the air cleaner according to a second embodiment.

FIG. 5A shows a fourth example of the schematic cross section of the air cleaner according to the second embodiment.

FIG. 5B shows a fifth example of the schematic cross section of the air cleaner according to the second embodiment.

FIG. 6 shows a sixth example of the schematic cross section of the air cleaner according to a third embodiment.

FIG. 7 shows a seventh example of the schematic cross section of the air cleaner according to the third embodiment.

FIG. 8 shows an eighth example of the schematic cross section of the air cleaner according to the third embodiment.

FIG. 9 shows a ninth example of the schematic cross section and details of a sensor unit of the air cleaner according to the third embodiment.

### DESCRIPTION OF EMBODIMENTS

Embodiments of the present invention will be described with reference to the drawings. In the following description, the same parts and components are designated with the same reference signs. Their names and functions are also identical.

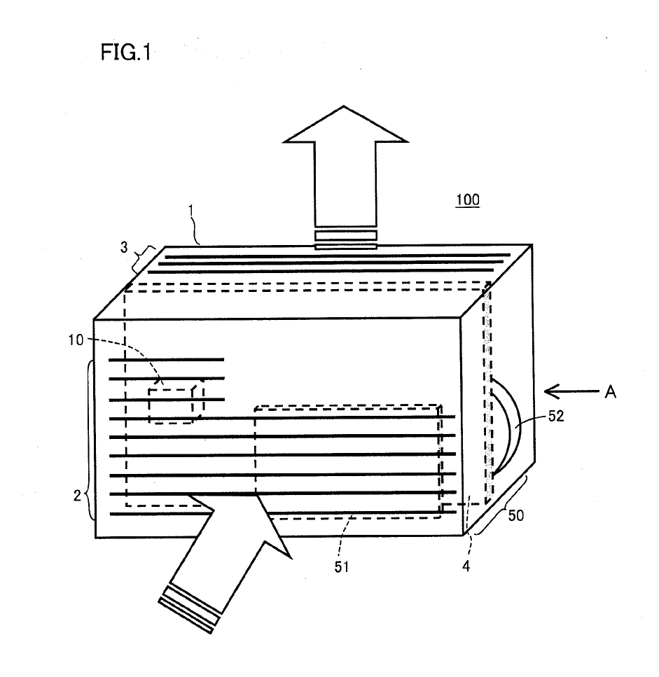

Referring to FIG. 1, an air cleaner 100 according to an embodiment includes a sensor unit 10 for sensing a substance to be sensed in the air, and an air cleaning mechanism 50, in a case 1.

Air cleaning mechanism 50 includes, as the most common air cleaning mechanism, a filter 51 and a fan 52. A specific mechanism of cleaning air in this case is such that dust and microorganisms contained in the outside air taken in from outside of the cleaner by fan 52 attach to filter 51 when the air passes through filter 51, and are removed to discharge cleaned air to the outside of the cleaner. Air cleaning mechanism 50 may have another structure.

Sensor unit 10 includes a sensor mechanism therein. Sensor unit 10 includes a hole on a side through which the outside air taken in from outside of the cleaner by fan 52 is introduced into sensor unit 10, and a hole on a side through which the air is discharged, which are not shown. When the outside air taken in from outside of the cleaner by fan 52 passes through the sensor mechanism, the passing air is sensed by the sensor mechanism.

Sensor unit 10 may be a microorganism sensor, for example. Sensor unit 10 which is a microorganism sensor may include a sensor mechanism for detecting microorganisms by irradiating the passing air with ultraviolet rays and receiving fluorescence from the microorganisms, a sensor mechanism for detecting microorganisms by irradiating the passing air with infrared rays and receiving scattered light of a predetermined angle to detect scattered light having intensity equal to or lower than a threshold value, or the like.

Sensor unit 10 may alternatively be a gas sensor for detecting combustible gas such as methane and carbon monoxide, as disclosed in Japanese Patent Laying-Open No. 63-229117. Sensor unit 10 which is a gas sensor may include a sensor mechanism for detecting gas concentration by measuring variations in electrical conductivity of a metal-oxide semiconductor, which are caused by adsorption of the gas contained in the passing air onto a surface of the metal-oxide semiconductor, or the like.

Case 1 includes an inlet 2 for taking in the outside air from outside of the cleaner, and an outlet 3 for discharging the air within the cleaner to the outside of the cleaner. Case 1 includes a separation wall 4 in a position where inlet 2 and outlet 3 are separated from each other. Sensor unit 10 and filter 51 are arranged near inlet 2 relative to separation wall 4, and fan 52 is arranged near outlet 3 relative to separation wall 4. Fan 52 is arranged in a position facing filter 51 with separation wall 4 therebetween. Separation wall 4 includes a vent at least in a portion where filter 51 is positioned.

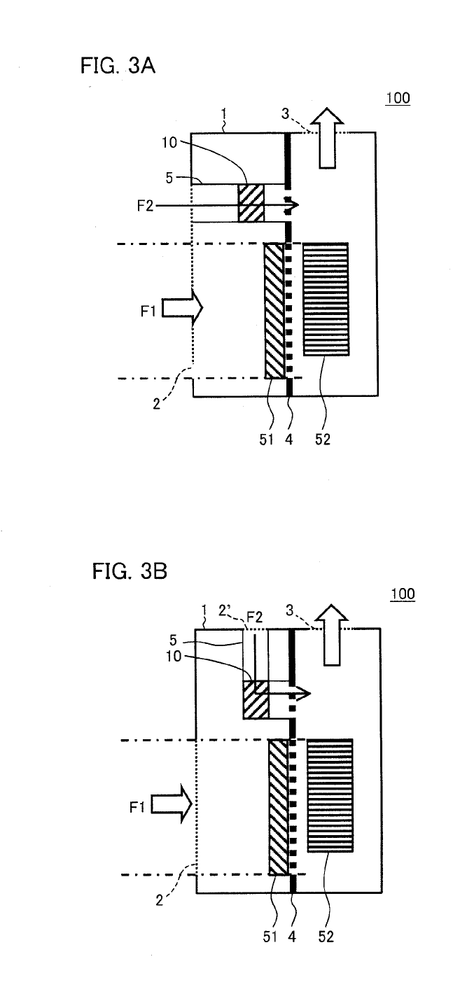

Fan 52 is driven to rotate to generate an airflow from inlet 2 toward outlet 3 through case 1. As a result, in a position where filter 51 is arranged in the cleaner, a flow path is formed where the outside air is taken in through inlet 2, passes through filter 51 and the vent of separation wall 4, and reaches outlet 3. This flow path will be referred to as a first flow path in the description below. The air passing through the first flow path is cleaned by air cleaning mechanism 50 and discharged. Moreover, in a position where sensor unit 10 is arranged in the cleaner, a flow path is formed where the outside air is taken through inlet 2, passes through sensor unit 10 and the vent of separation wall 4, and reaches outlet 3. This flow path will be referred to as a second flow path in the description below. The air passing through the second flow path is sensed by sensor unit 10 and discharged. Preferably, case 1 includes a flow path pipe 5 for forming the second flow path, which extends downstream of at least sensor unit 10 (FIG. 3 and the like).

Preferably, air cleaner 100 includes a not-shown controller. The controller is electrically connected to at least sensor unit 10 and fan 52, and controls driving of fan 52 to rotate based on a sensing result from sensor unit 10.

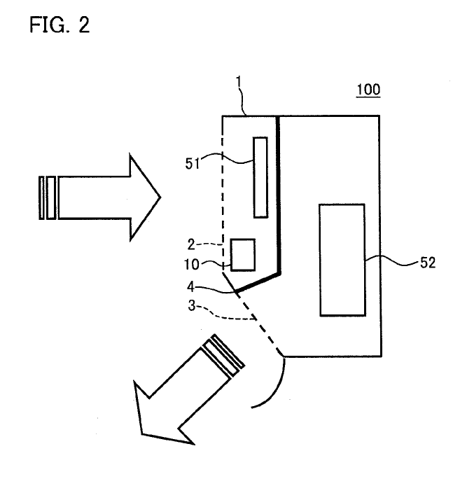

Air cleaner 100 is assumed to be installed in a lower portion with respect to space where the air therein is to be cleaned, such as on the floor of a room. In air cleaner 100, therefore, as shown in FIG. 1, outlet 3 is arranged near an upper surface of case 1, and sensor unit 10 is also arranged in an upper portion in case 1. Air cleaner 100 may be assumed to be installed in an upper portion with respect to space where the air therein is to be cleaned, such as on the ceiling of a room. Alternatively, air cleaner 100 may be incorporated into an air conditioner or the like, and installed near the ceiling of a room. If air cleaner 100 is installed in an upper portion with respect to space where the air therein is to be cleaned, as shown in FIG. 2, outlet 3 is arranged near a lower surface of case 1, and sensor unit 10 is also arranged in a lower portion in case 1. With such arrangement, the cleaned air is readily supplied to the target space, and sensor unit 10 can readily sense the air within the space.

Positional relation between sensor unit 10 and filter 51 is not limited to those shown in FIGS. 1 and 2, but will be described later in detail.

### First Embodiment

Referring to FIGS. 3A and 3B, the positional relation between sensor unit 10 and filter 51 in a first embodiment will be described. FIGS. 3A and 3B show lateral cross sections of air cleaner 100, namely, a first example and a second example of a schematic cross section seen in a direction of an arrow A in FIG. 1, respectively.

In the first embodiment, sensor unit 10 is arranged outside of the first flow path passing through filter 51, and the first flow path and the second flow path form different flow paths.

In the first example shown in FIG. 3A, sensor unit 10 is arranged near inlet 2 relative to separation wall 4 in case 1, outside of a first flow path F1. Separation wall 4 includes a vent in a position corresponding to filter 51 and in a position corresponding to sensor unit 10, respectively, and case 1 includes flow path pipe 5 extending from inlet 2 to the corresponding vent of separation wall 4 via sensor unit 10. Flow path pipe 5 need not include inlet 2, and is only required to extend downstream of at least sensor unit 10.

When fan 52 rotates to reduce pressure between separation wall 4 and fan 52, the outside air is taken in through inlet 2, and passes through filter 51 and the corresponding vent of separation wall 4, and sensor unit 10 and the corresponding vent of separation wall 4, respectively. That is, when fan 52 rotates, a second flow path F2 passing through sensor unit 10 is formed as a flow path different from first flow path F1. Alternatively, as in the second example shown in FIG. 3B, an inlet 2′ for supplying air to sensor unit 10 may be further provided in an upper portion of case 1, and case 1 may include flow path pipe 5 extending from inlet 2′ to the corresponding vent of separation wall 4 via sensor unit 10.

With sensor unit 10 being arranged outside of the first flow path passing through filter 51, and with the second flow path passing through sensor unit 10 being different from the first flow path, the outside air to be sensed by sensor unit 10 is taken in through the flow path different from the flow path for the outside air to be cleaned by filter 51, and delivered to sensor unit 10. As a result, sensor unit 10 included in air cleaner 100 can accurately sense the air outside of the cleaner.

Furthermore, with sensor unit 10 being arranged outside of the first flow path as shown in FIGS. 3A and 3B, sensor unit 10 is located farther away from fan 52 arranged in the position facing filter 51, than from filter 51. With this positional relation, pulling pressure acting on the first flow path generated by the rotation of fan 52 becomes higher than pulling pressure acting on the second flow path, so that a flow rate in the second flow path can be made lower than a flow rate in the first flow path without reducing the flow rate in the first flow path. That is, a period of time during which the sensor mechanism in sensor unit 10 can sense the air therein can be made longer than a period of time during which the air passes with the flow rate in the first flow path, without reducing the flow rate in the first flow path.

When the sensor mechanism is a mechanism for detecting microorganisms by irradiating the air passing through sensor unit 10 with light and receiving fluorescence or scattered light as described above, for example, the light can be received reliably with a certain period of time during which the air passes through sensor unit 10. When the sensor mechanism is a mechanism for detecting concentration of gas contained in the passing air by measuring adsorption of the gas onto a surface of a metal-oxide semiconductor as discussed above, for example, again, the gas adsorption is more likely with a certain period of time during which the air passes through sensor unit 10. If a sensor function requires time for sensing other substances, such sensing is possible by extending the period of time during which the air passes through sensor unit 10. Accordingly, sensing accuracy can be improved while the performance of the air cleaning mechanism in air cleaner 100 is maintained.

In the first example and the second example shown in FIGS. 3A and 3B, respectively, case 1 includes flow path pipe 5, and second flow path F2 is formed in flow path pipe 5 by the rotation of fan 52. Flow path pipe 5 need not be provided, however. If fan 52 is larger than in FIGS. 3A and 3B and has a size covering both sensor unit 10 and filter 51, with a distance between fan 52 and sensor unit 10 being substantially equal to a distance between fan 52 and filter 51, for example, the outside air taken in through inlet 2 separately passes through sensor unit 10 and filter 51 and passes through the corresponding vents of separation wall 4, respectively, to form the first flow path and the second flow path different from each other, without providing flow path pipe 5. Alternatively, if fan 52 is provided in a position different from those shown in FIGS. 3A and 3B such as in a position farther away from separation wall 4 or in an upper portion, the first flow path and the second flow path different from each other will be similarly formed. The same applies in the following examples as well.

It should be noted that an amount of air passing through second flow path F2 and sensed by sensor unit 10 is extremely small compared to an amount of air passing through the first flow path and cleaned by filter 51. Thus, even if the air is discharged without passing through filter 51 after being sensed by sensor unit 10, the performance of the air cleaning mechanism in air cleaner 100 is not affected.

### Second Embodiment

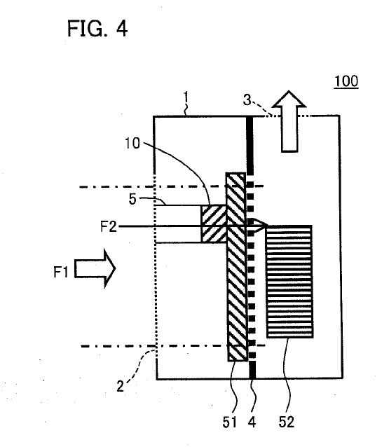

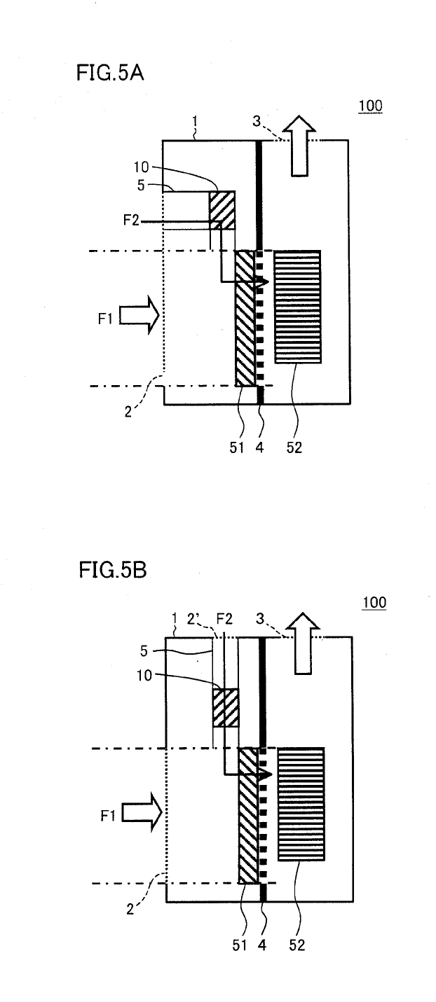

Referring to FIGS. 4, 5A and 5B, the positional relation between sensor unit 10 and filter 51 in a second embodiment will be described. FIGS. 4, 5A and 5B also show lateral cross sections of air cleaner 100, namely, a third example, a fourth example and a fifth example of the schematic cross section seen in the direction of arrow A in FIG. 1, respectively.

In the second embodiment, sensor unit 10 is arranged upstream of filter 51 in the first flow path passing through filter 51, and the second flow path passing through sensor unit 10 meets the first flow path at least in a downstream portion of the first flow path.

In the third example shown in FIG. 4, sensor unit 10 is arranged between filter 51 and inlet 2 in the first flow path. In other words, sensor unit 10 is arranged upstream of filter 51 in first flow path F1. In this arrangement, second flow path F2 is included in first flow path F1.

Although case 1 includes flow path pipe 5, and flow path pipe 5 forms second flow path F2 in the third example as well, flow path pipe 5 need not be provided if sensor unit 10 is arranged in first flow path F1.

An upstream side of filter 51 in the first flow path passing through filter 51 includes a portion outside of the first flow path. That is, sensor unit 10 may be arranged between filter 51 and inlet 2 outside of the first flow path. In the fourth example and the fifth example shown in FIGS. 5A and 5B, sensor unit 10 is provided between filter 51 and inlet 2 outside of the first flow path. In other words, sensor unit 10 is arranged upstream of filter 51 outside of first flow path F1. In the fourth and fifth examples, separation wall 4 includes a vent in a position corresponding to filter 51, and does not include a vent in a position corresponding to sensor unit 10.

When fan 52 rotates to reduce pressure between separation wall 4 and fan 52, the outside air is taken in through inlet 2, and passes through filter 51 and sensor unit 10, respectively. The air that has passed through sensor unit 10 then passes through filter 51 due to the pulling pressure acting by the rotation of fan 52. That is, in these arrangements, second flow path F2 meets first flow path F1 upstream of filter 51 by the rotation of fan 52. In the fifth example of FIG. 5B, inlet 2′ for supplying air to sensor unit 10 is further provided in an upper portion of case 1, as already shown in FIG. 3B.

Although case 1 includes flow path pipe 5, and flow path pipe 5 forms second flow path F2 in the examples shown in FIGS. 5A and 5B as well, flow path pipe 5 need not be provided, since the air that has passed through sensor unit 10 then passes through filter 51 because the vent is provided in the position corresponding to filter 51 and not provided in the position corresponding to sensor unit 10.

With sensor unit 10 being arranged upstream of filter 51 in the first flow path passing through filter 51, the outside air is taken in through inlet 2 (or inlet 2′), and sensed by sensor unit 10 upstream of filter 51, namely, before reaching filter 51. Accordingly, sensor unit 10 can sense the air before the air is cleaned by filter 51. As a result, sensor unit 10 included in air cleaner 100 can accurately sense the air outside of the cleaner.

As described above, the amount of air passing through second flow path F2 and sensed by sensor unit 10 is very small compared to the amount of air passing through the first flow path and cleaned by filter 51, and does not affect the performance of the air cleaning mechanism in air cleaner 100 even if not cleaned by filter 51. Nevertheless, with sensor unit 10 being arranged upstream of filter 51 in the first flow path passing through filter 51, the air that has been sensed by sensor unit 10 meets first flow path F1 (or is included in first flow path F1), so that the air that has been sensed is also cleaned by filter 51. As a result, the performance of the air cleaning mechanism in air cleaner 100 can be further improved.

### Third Embodiment

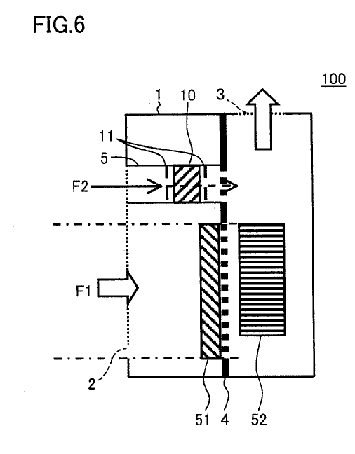

Referring to FIGS. 6 to 9, the structure of the second flow path passing through sensor unit 10 in a third embodiment will be described. FIGS. 6 to 8 and 9(A) also show lateral cross sections of air cleaner 100, namely, a sixth example to a ninth example of the schematic cross section seen in the direction of arrow A in FIG. 1, respectively.

In the third embodiment, as in the first embodiment, sensor unit 10 is arranged outside of the first flow path passing through filter 51, and the second flow path is formed as a flow path different from the first flow path. Moreover, in the third embodiment, flow path pipe 5 for forming the second flow path includes a structure for controlling a flow volume or a flow rate to vary between an upstream side and a downstream side of sensor unit 10.

In the sixth example shown in FIG. 6, flow path pipe 5 includes an adjustment wall 11 having a vent, as a structure for controlling the flow volume or the flow rate, upstream and downstream of sensor unit 10. The vent formed in adjustment wall 11 has a size smaller than at least the cross section of flow path pipe 5. Accordingly, adjustment wall 11 interferes with an airflow within flow path pipe 5. With adjustment wall 11 being provided upstream of sensor unit 10 in flow path pipe 5, a flow volume per unit time of air flowing into sensor unit 10 becomes lower than a flow volume of air delivered to sensor unit 10 by the rotation of fan 52. In addition, with adjustment wall 11 being provided downstream of sensor unit 10 in the second flow path, a flow volume per unit time of air discharged from sensor unit 10 becomes lower than the flow volume of air delivered to sensor unit 10 by the rotation of fan 52. That is, a flow rate of air passing through sensor unit 10 becomes lower than a flow rate of air delivered to sensor unit 10 by the rotation of fan 52.

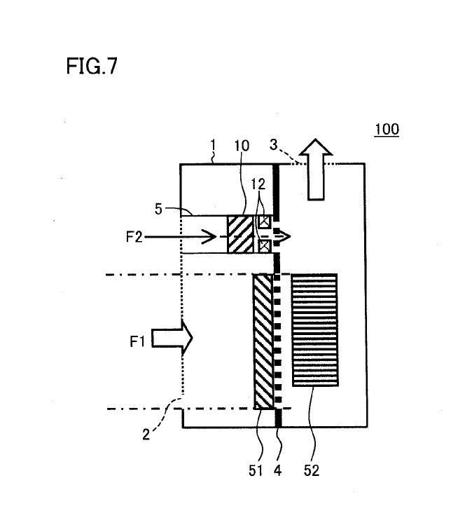

Although adjustment wall 11 is arranged on both sides of sensor unit 10 in flow path pipe 5 in the sixth example, adjustment wall 11 may be arranged at least on one side, for example, only downstream of sensor unit 10. That is, as in the seventh example shown in FIG. 7, an obstacle 12 may be arranged, as a structure for controlling the flow volume or the flow rate, downstream of sensor unit 10 in flow path pipe 5. With obstacle 12, a flow volume of air discharged from sensor unit 10 becomes lower than a flow volume per unit time of air introduced into sensor unit 10 by the rotation of fan 52. That is, the air that has flown into sensor unit 10 remains in sensor unit 10 for some time.

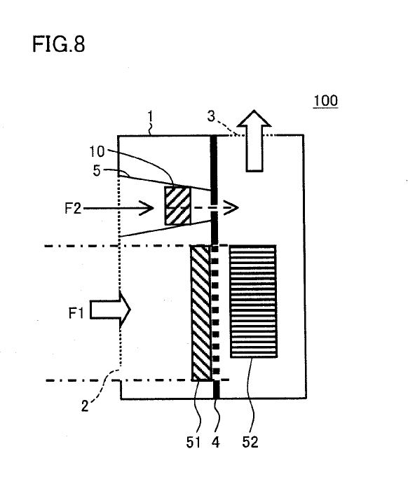

Instead of installing adjustment wall 11 or obstacle 12, as in the eighth example shown in FIG. 8, the width of flow path pipe 5 may be narrowed from an air introduction side toward an air discharge side of sensor unit 10, as a structure for controlling the flow volume or the flow rate. When the second flow path is formed without flow path pipe 5 described above, the size of the vent formed in separation wall 4 in the position corresponding to sensor unit 10 may be made smaller than that of inlet 2, to realize a structure for controlling the flow volume or the flow rate. With flow path pipe 5 having this structure, again, the flow volume of air discharged from sensor unit 10 becomes lower than the flow volume per unit time of air introduced into sensor unit 10 by the rotation of fan 52. That is, the air that has flown into sensor unit 10 remains in sensor unit 10 for some time.

Alternatively, instead of installing adjustment wall 11 or obstacle 12, a structure for controlling the flow volume or the flow rate may be provided upstream (inflow side) and downstream (discharge side) of sensor unit 10 itself.

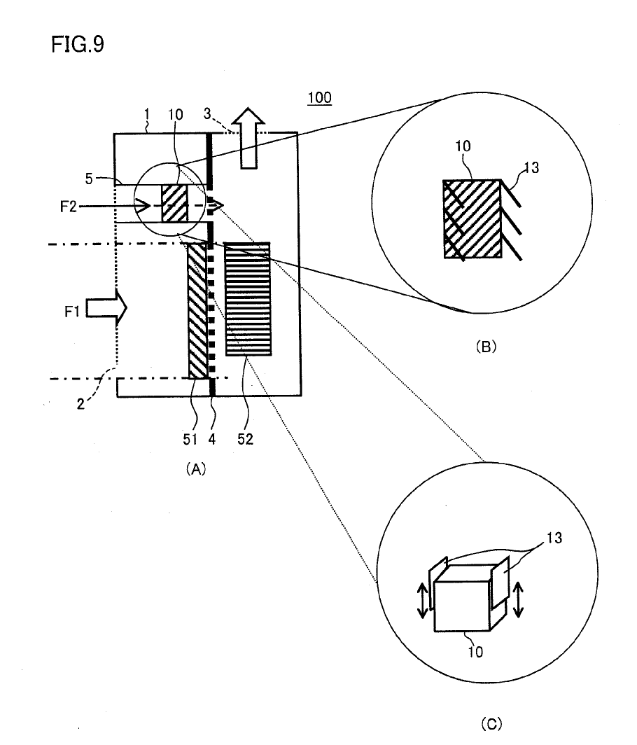

FIG. 9(B) shows details of sensor unit 10 in the ninth example. In this example, sensor unit 10 includes a shielding plate 13 for flow volume adjustment in a position of a hole on the air introduction side and in a position of a hole on the air discharge side of sensor unit 10. Shielding plate 13 has one side rotatably joined to a hole surface of sensor unit 10, and an angle formed with the hole surface is adjustable. An air inflow or discharge is not interfered with if the angle formed between shielding plate 13 and the hole surface is equal to or greater than 90 degrees, and the hole on the air introduction side or the hole on the air discharge side is completely blocked if the angle is 0 degree, with the extent of interference becoming greater with a decrease of the angle from 90 degrees. The angle may be fixed in advance depending on the type (characteristics) of the sensor mechanism in sensor unit 10, for example, or a mechanism for changing the angle may be connected to a not-shown controller which controls the angle depending on conditions that affect the sensor mechanism such as temperature and humidity, or the angle may be adjusted at regular time intervals. Alternatively, the angle may be controlled independently between the introduction side and the discharge side of sensor unit 10. Alternatively, shielding plate 13 may be provided only on one of the introduction side and the discharge side, as with adjustment wall 11.

FIG. 9(C) shows another example of details of sensor unit 10 in the ninth example. As shown in this example, shielding plate 13 may be provided in a manner slidable parallel or substantially parallel to the hole surface. The larger the portion of shielding plate 13 and the hole overlapping each other, the higher the extent of interference with air inflow or discharge. An amount of sliding of shielding plate 13 relative to the hole may also be fixed in advance depending on the type (characteristics) of the sensor mechanism in sensor unit 10, for example, or a mechanism for sliding shielding plate 13 may be connected to a not-shown controller which controls the amount of sliding depending on the conditions that affect the sensor mechanism such as temperature and humidity, or shielding plate 13 may be opened and closed at regular time intervals. Alternatively, the amount of sliding may be controlled independently between the introduction side and the discharge side of sensor unit 10. Alternatively, shielding plate 13 may be provided only on one of the introduction side and the discharge side.

With the structure for controlling the flow volume or the flow rate being included in flow path pipe 5, the flow rate of air passing through sensor unit 10 is reduced. Alternatively, the air that has flown into sensor unit 10 remains in sensor unit 10 for an extended period of time. As a result, the sensing accuracy of sensor unit 10 can be improved, as described above.

Furthermore, with the second flow path being formed as a flow path different from the first flow path, the cleaning in the first flow path, namely, by filter 51, is not affected even if the flow rate in the second flow path is reduced. Accordingly, the sensing accuracy of sensor unit 10 can be improved while the performance of the air cleaning mechanism in air cleaner 100 is maintained.

### [Modification]

Shielding plate 13 illustrated in FIG. 9(A) or (B) may be provided on sensor unit 10 when sensor unit 10 is arranged upstream of filter 51 in the first flow path as in the examples shown in FIGS. 4, 5A and 5B. As a result, the outside air is taken into the cleaner, and can be sensed by sensor unit 10 before reaching filter 51, and the flow volume or the flow rate in sensor unit 10 can be reduced.

As described above, the amount of air passing through second flow path F2 and sensed by sensor unit 10 is extremely small compared to the amount of air passing through the first flow path and cleaned by filter 51. Thus, the performance of the air cleaning mechanism in air cleaner 100 is not affected even if the flow rate in the second flow path passing through sensor unit 10 in the first flow path is reduced. With such structure, therefore, sensor unit 10 included in air cleaner 100 can accurately and precisely sense the air outside of the cleaner while the performance of the air cleaning mechanism in air cleaner 100 is maintained.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1 case; 2, 2′ inlet; 3 outlet; 4 separation wall; 5 flow path pipe; 10 sensor unit; 11 adjustment wall; 12 obstacle; 13 shielding plate; 50 air cleaning mechanism; 51 filter; 52 fan; 100 air cleaner.

1-11. (canceled)

12. An air cleaner comprising:
a case including an inlet and an outlet;
an air cleaning mechanism in said case for cleaning air taken in through said inlet;
a sensor mechanism in said case for sensing the air taken in through said inlet; and a flow volume control mechanism for controlling the air taken in through said inlet such that a flow rate of the air passing through said sensor mechanism is lower than a flow rate of the air passing through said air cleaning mechanism.

13. The air cleaner according to claim 12, wherein
said flow volume control mechanism is a flow path wall for separating an airflow from said inlet to said sensor mechanism, from an airflow from said inlet to said air cleaning mechanism.

14. The air cleaner according to claim 12, wherein
said flow volume control mechanism includes at least one of a member provided upstream of said sensor mechanism for interfering with an inflow of air into said sensor mechanism, and a member provided downstream of said sensor mechanism for interfering with discharge of air from said sensor mechanism.

15. The air cleaner according to claim 14, wherein
said sensor mechanism includes an inlet and an outlet upstream and downstream thereof, respectively, and
said flow volume control mechanism includes a member in contact with at least one of a surface having said inlet of said sensor mechanism and a surface having said outlet of said sensor mechanism, for changing an opening area of said inlet or said outlet.

16. The air cleaner according to claim 15, wherein
said member for changing an opening area is joined such that an angle formed with said at least one of said surface having said inlet of said sensor mechanism and said surface having said outlet of said sensor mechanism is variable, and changes the opening area of said inlet or said outlet by control of said angle.

17. The air cleaner according to claim 15, wherein
said member for changing an opening area is joined in a manner slidable parallel or substantially parallel to said at least one of said surface having said inlet of said sensor mechanism and said surface having said outlet of said sensor mechanism, and changes the opening area of said inlet or said outlet by control of an amount of sliding.

18. The air cleaner according to claim 12, further comprising an airflow generation device, wherein
said air cleaning mechanism cleans the air taken into said case through said inlet and passing through said air cleaning mechanism by driving of said airflow generation device,
said sensor mechanism senses the air taken into said case through said inlet and passing through said sensor mechanism by driving of said airflow generation device, to detect a substance to be sensed contained in said air,
said sensor mechanism is arranged in said case, upstream of said air cleaning mechanism in a flow path where the air taken into said case through said inlet by driving of said airflow generation device passes through said air cleaning mechanism from said inlet, and
said flow volume control mechanism makes a flow rate of the air passing through at least said sensor mechanism lower than a flow rate of the air reaching said sensor mechanism from said inlet by driving of said airflow generation device.

19. The air cleaner according to claim 18, wherein
said sensor mechanism includes an inlet and an outlet upstream and downstream thereof, respectively, and
said flow volume control mechanism includes a member in contact with at least one of a surface having said inlet of said sensor mechanism and a surface having said outlet of said sensor mechanism, for changing an opening area of said inlet or said outlet.

20. The air cleaner according to claim 19, wherein
said member for changing an opening area is joined such that an angle formed with said at least one of said surface having said inlet of said sensor mechanism and said surface having said outlet of said sensor mechanism is variable, and changes the opening area of said inlet or said outlet by control of said angle.

21. The air cleaner according to claim 19, wherein
said member for changing an opening area is joined in a manner slidable parallel or substantially parallel to said at least one of said surface having said inlet of said sensor mechanism and said surface having said outlet of said sensor mechanism, and changes the opening area of said inlet or said outlet by control of an amount of sliding.
